(19) United States
(12) Patent Application Publication
(10) Pub. No.: US 2013/0280598 A1
(43) Pub. Date: Oct. 24, 2013

(54) Solid State Battery

(71) Applicant: MURATA MANUFACTURING CO., LTD., Nagaokakyo-Shi (JP)

(72) Inventors: Satoshi Shigematsu, Nagaokakyo-Shi (JP); Kazuhiro Yamada, Nagaokakyo-Shi (JP); Masanori Endo, Nagaokakyo-Shi (JP)

(21) Appl. No.: 13/917,765

(22) Filed: Jun. 14, 2013

Related U.S. Application Data
(63) Continuation of application No. PCT/JP2011/076997, filed on Nov. 24, 2011.

(30) Foreign Application Priority Data
Dec. 15, 2010 (JP) 2010-279104

(51) Int. Cl. H01M 2/30

(52) U.S. Cl. CPC H01M 2/30
USPC 429/178; 429/163

(57) ABSTRACT

A mounting type solid state battery which includes a battery laminate body and a case housing the battery laminate body. The battery laminate body is formed by laminating a positive electrode layer, a solid electrolyte layer and a negative electrode layer in order. The case main body has a base part which supports the battery laminate body. The positive electrode layer and the negative electrode layer are laminated in a direction in which the base part of the case main body extends.

### CROSS REFERENCE TO RELATED APPLICATIONS

The present application is a continuation of International application No. PCT/JP2011/076997, filed Nov. 24, 2011, which claims priority to Japanese Patent Application No. 2010-279104, filed Dec. 15, 2010, the entire contents of each of which are incorporated herein by reference.

### FIELD OF THE INVENTION

The present invention generally relates to a solid state battery, and more particularly to a solid state battery having a positive electrode layer, a solid electrolyte layer and a negative electrode layer which are laminated.

### BACKGROUND OF THE INVENTION

A lithium ion secondary battery using a nonaqueous electrolytic solution and the like are used for a power supply for small electronic equipment, an auxiliary power supply for memory backup or the like. However, the lithium ion secondary battery of the above configuration has a risk that an electrolyte solution leaks. Therefore, if the lithium ion secondary battery of the above configuration is used for an auxiliary power supply for memory backup or the like, when surrounding electronic circuits become wet by a leaked electrolytic solution, problems that the electronic circuit breaks down or malfunctions arise. In order to avoid the problem, it has been conventionally performed to mount a lithium ion secondary battery and an electronic circuit on different locations.

However, in recent years, in an electronic equipment in which further miniaturization is required, it becomes an impediment to miniaturization to mount a battery and an electronic circuit on different locations. Hence, in recent years, a battery capable of being mounted on a substrate on which an electronic circuit is mounted has been contrived.

For example, in Japanese Patent Laid-open Publication No. 2002-42885 (hereinafter, referred to as Patent Document 1) and Japanese Patent Laid-open Publication No. 2010-118159 (hereinafter, referred to as Patent Document 2), a configuration of a battery which can be mounted on a substrate together with electronic circuit parts has been proposed.

In these batteries, a battery laminate body including a positive electrode layer, a negative electrode layer and a solid electrolyte layer disposed between these layers is housed in a case (outer casing) which can be mounted on a substrate. Further, in these batteries, battery laminate bodies are arranged so as to be laminated in a direction perpendicular to a mounting surface of the substrate. That is, the battery laminate bodies are laminated in such a way that the positive electrode layers or negative electrode layers in the battery laminate bodies are positioned at a top surface of the battery laminate body. The positive electrode layer and negative electrode layer of the battery laminate body are respectively connected to an external terminal or a current collector by wire bonding, a conductive adhesive or the like in a case.

Patent Document 1: Japanese Patent Laid-open Publication No. 2002-42885

Patent Document 2: Japanese Patent Laid-open Publication No. 2010-118159

### SUMMARY OF THE INVENTION

In the configuration of the battery described in Patent Document 1, an IC chip is disposed on the battery, and the IC chip is connected to an electrode of the battery through an opening. In this case, since the IC chip is disposed on the battery, a low-profile configuration is insufficient. Also when the battery and the IC chip are lined laterally and mounted on a circuit board or the like, since the IC chip is connected to an electrode of the battery by wire bonding through an opening, a mounting area is increased. For these reasons, it is difficult that the configuration of the battery responds to the demand of further downsizing of electronic equipment.

Further, in the configuration of the battery described in Patent Document 2, a connecting electrode part of a case formed on the bottom surface of the case is connected to an electronic circuit wiring or the like on a substrate by reflow soldering or the like, and thereby, the battery is mounted on the substrate. This battery can be easily mounted on the substrate without increasing a mounting area since the connecting electrode part of the case, which is connected to the electronic circuit wiring or the like on the substrate, is positioned at the bottom surface of the case. However, also in this battery, it is difficult to further downsize a mounting type battery including a battery laminate body and a case housing the battery laminate body since an electrode of the battery laminate body is connected to the connecting electrode part of the case located at the bottom surface of the case by wire bonding.

Hence, it is an object of the present invention to downsize a solid state battery including a battery laminate body and a case housing the battery laminate body.

The solid state battery according to the present invention comprises a battery laminate body formed by laminating a positive electrode layer, a solid electrolyte layer and a negative electrode layer in order, and a case main body housing the battery laminate body. The case main body has a base part which supports the battery laminate body. The positive electrode layer and the negative electrode layer are laminated in a direction in which the base part of the case main body extends.

In the solid state battery of the present invention, the positive electrode layer and the negative electrode layer are laminated in the direction in which the base part of the case main body extends. Therefore, when the base part of the case main body is placed on the surface of a substrate, the positive electrode layer and the negative electrode layer can be arranged next to each other in the direction in which the surface of the substrate extends. According to this configuration, the respective surfaces of the positive electrode layer and the negative electrode layer can face the surface of the substrate. Accordingly, since each of the positive electrode layer and the negative electrode layer can be easily connected to an electronic circuit wiring or the like on the substrate, a battery can be easily mounted on the substrate, for example, when the battery is surface-mounted on the substrate.

Further, it is not necessary that in the case main body, the positive electrode layer and negative electrode layer of the battery laminate body are connected to a connection terminal part for connecting to an electronic circuit wiring or the like on the substrate by wire bonding or the like. According to this configuration, a mounting type solid state battery including a battery laminate body and a case housing the battery laminate body can be downsized.

In the solid state battery of the present invention, an electrode connecting part for bringing an inner side surface of the case main body into conduction with an outer side surface of the case main body is formed at the base part of the case main body, and the electrode connecting part preferably includes a positive electrode connecting part to be connected to the positive electrode layer and a negative electrode connecting part to be connected to the negative electrode layer. According to this configuration, a mounting type solid state battery, which can be easily surface-mounted on a substrate and includes a battery laminate body and a case housing the battery laminate body, can be downsized.

In the above case, a current collector layer is preferably formed on each of the surface of the positive electrode layer on a side which is connected to the positive electrode connecting part and the surface of the negative electrode layer on a side which is connected to the negative electrode connecting part.

Moreover, in the above case, preferably, the battery laminate body has one surface opposite to the surface of the base part, and the other surface opposite to the one surface, and an insulating layer is arranged so as to be brought into contact with the other surface described above.

Preferably, the case main body has a lid portion arranged so as to cover the battery laminate body, and the insulating layer is disposed between the lid portion and the battery laminate body.

Further, the case main body has a lid portion arranged so as to cover the battery laminate body, and the insulating layer may be configured so as to form a part of the lid portion.

When the insulating layer is not formed, a bump layer is preferably formed on each of the surface of the positive electrode connecting part on a side which is connected to the positive electrode layer and the surface of the negative electrode connecting part on a side which is connected to the negative electrode layer.

In the above case, the case main body preferably has a lid portion arranged so as to cover the battery laminate body.

According to the present invention, a state battery including a battery laminate body and a case housing the battery laminate body can be downsized.

### BRIEF EXPLANATION OF THE DRAWINGS

FIG. 1 is a sectional view showing a schematic cross-section of a solid state battery as a first embodiment of the present invention.

FIG. 2 is a sectional view showing a schematic cross-section of a solid state battery as a second embodiment of the present invention.

FIG. 3 is a sectional view showing a schematic cross-section of a solid state battery as a third embodiment of the present invention.

FIG. 4 is a perspective view showing a battery laminate body in a solid state battery of an embodiment of the present invention.

FIG. 5 is a view showing patterns (A) to (E) of current collector layers formed on each of a positive electrode layer and a negative electrode layer of the battery laminate body in the solid state battery of the present invention.

FIG. 6 is a perspective view showing a battery laminate body in a solid state battery prepared in Example of the present invention.

FIG. 7 is a view showing one pattern of current collector layers formed on each of a positive electrode layer and a negative electrode layer of the battery laminate body in the solid state battery prepared in Example of the present invention, which is a view viewed from a direction of an arrow VII in FIG. 6.

FIGS. 8(A) and 8(B) are perspective views showing an appearance of the solid state battery prepared in Example of the present invention.

FIG. 9 is a schematic perspective view showing a base part of a case main body in the solid state battery prepared in Example of the present invention.

FIG. 10 is a view showing another pattern of current collector layers formed on each of a positive electrode layer and a negative electrode layer of the battery laminate body in the solid state battery prepared in Example of the present invention.

FIG. 11 is a sectional view showing a schematic cross-section of a solid state battery as a fourth embodiment of the present invention.

FIG. 12 is a sectional view showing a schematic cross-section of a solid state battery as a fifth embodiment of the present invention.

### DETAILED DESCRIPTION OF THE INVENTION

Hereinafter, embodiments of the solid state battery of the present invention will be described.

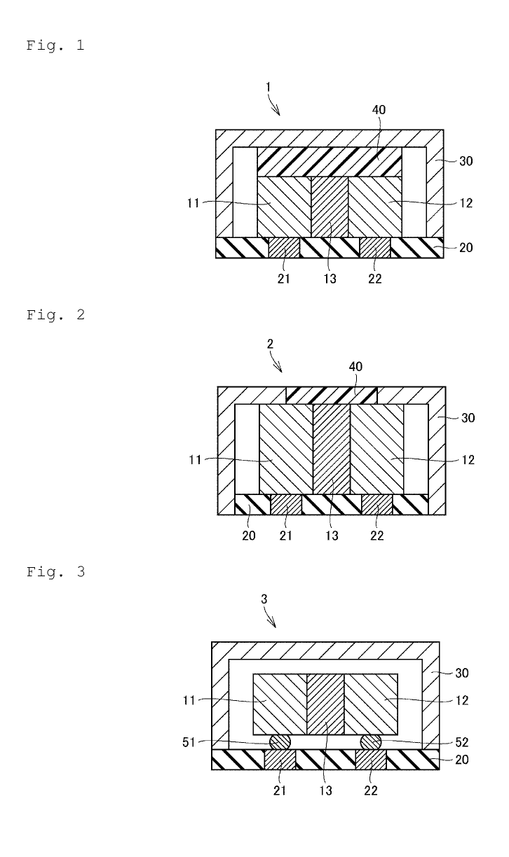

As shown in FIG. 1, in a first embodiment of the present invention, a mounting type solid state battery 1 comprises a battery laminate body formed by laminating a positive electrode layer 11, a solid electrolyte layer 13 and a negative electrode layer 12 in order, and a case main body housing the battery laminate body. The case main body is composed of a base part 20 and a lid portion 30. The battery laminate body is placed on the surface of the base part 20 so as to be supported by the base part 20. A positive electrode connecting part 21 and a negative electrode connecting part 22 are formed at the base part 20 as an electrode connecting part for bringing an inner side surface of the case main body into conduction with an outer side surface of the case main body. The battery laminate body is disposed on the surface of the base part 20 so that the positive electrode connecting part 21 is connected to the positive electrode layer 11 and the negative electrode connecting part 22 is connected to the negative electrode layer 12. The lid portion 30 is arranged so as to cover the battery laminate body. The base part 20 is joined to the lid portion 30 by seam welding or the like. The positive electrode layer 11, the solid electrolyte layer 13 and the negative electrode layer 12 are laminated in a direction in which the base part 20 of the case main body extends. An insulating layer 40 is arranged so as to be brought into contact with the surface of the battery laminate body opposite to the surface facing the base part 20. In the first embodiment, the insulating layer 40 is disposed between the battery laminate body and the lid portion 30.

As shown in FIG. 2, in a mounting type solid state battery 2 as a second embodiment of the present invention, an insulating layer 40 forms a part of a lid portion 30. The other configuration of the solid state battery 2 is similar to that of the solid state battery 1.

As shown in FIG. 3, in a mounting type solid state battery 3 as a third embodiment of the present invention, an insulating layer is not disposed on the surface of the battery laminate body opposite to the surface facing the base part 20. However, a positive electrode bump layer 51 is disposed between a positive electrode layer 11 and a positive electrode connecting part 21, and a negative electrode bump layer 52 is disposed between a negative electrode layer 12 and a negative electrode connecting part 22. The other configuration of the solid state battery 3 is similar to that of the solid state battery 1.

In addition, in the solid state batteries 1 to 3, a gap is present between an outer peripheral surface of the battery laminate body and an inner peripheral surface of the lid portion 30 of the case main body, but the outer peripheral surface of the battery laminate body may be in close contact with the lid portion 30 of the case main body without the gap. The base part 20 and lid portion 30 of the case main body are formed from metal, ceramic or the like. The base part 20 may be formed from ceramic such as alumina, and the lid portion 30 may be formed from metal such as Kovar (Co—Ni—Fe alloy). The insulating layer 40 is formed from ceramic such as alumina, synthetic resins such as fluorine resins (tetrafluoroethylene resin, etc.) and polyimide resins, or the like. The positive electrode connecting part 21 and the negative electrode connecting part 22 are formed from metal such as tungsten filled into a through-hole formed in the base part 20. The positive electrode bump layer 51 and the negative electrode bump layer 52 are made of solder, gold or the like.

In the solid state batteries 1 to 3 of the present invention thus configured, the positive electrode layer 11 and the negative electrode layer 12 are laminated in a direction in which the base part 20 of the case main body extends. Therefore, when the base part 20 of the case main body is placed on the surface of a substrate, the positive electrode layer 11 and the negative electrode layer 12 can be arranged next to each other in a direction in which the surface of the substrate extends. According to this configuration, the respective surfaces of the positive electrode layer 11 and the negative electrode layer 12 can face the surface of the substrate. As a result, since both the positive electrode layer 11 and the negative electrode layer 12 can be directly connected to one surface of the substrate, routing of wiring becomes unnecessary. Therefore, an area necessary for wiring is reduced. As described above, since each of the positive electrode layer 11 and the negative electrode layer 12 can be easily connected to an electronic circuit wiring or the like on the substrate, the solid state batteries 1 to 3 can be easily mounted on the substrate.

Further, it is not necessary that in the case main body, the positive electrode layer 11 and negative electrode layer 12 of the battery laminate body are connected to the positive electrode connecting part 21 and the negative electrode connecting part 22, respectively, as a connection terminal part for connecting to an electronic circuit wiring or the like on the substrate by wire bonding or the like. According to this configuration, mounting type solid state batteries 1 to 3 including a battery laminate body and a case housing the battery laminate body can be downsized. In addition, it is particularly effective in the case of surface-mounting the solid state batteries 1 to 3 of the present invention since each of the positive electrode layer and the negative electrode layer can be connected to an electronic circuit wiring or the like on the substrate without increasing a mounting area.

In the solid state batteries 1 and 2, since the insulating layer 40 is located on the battery laminate body, the insulating layer 40 acts to press the battery laminate body against the base part 20 of the case main body. Therefore, a displacement of the battery laminate body in the case main body can be prevented. Further, when the lid portion 30 is formed from metal, electric short can be prevented.

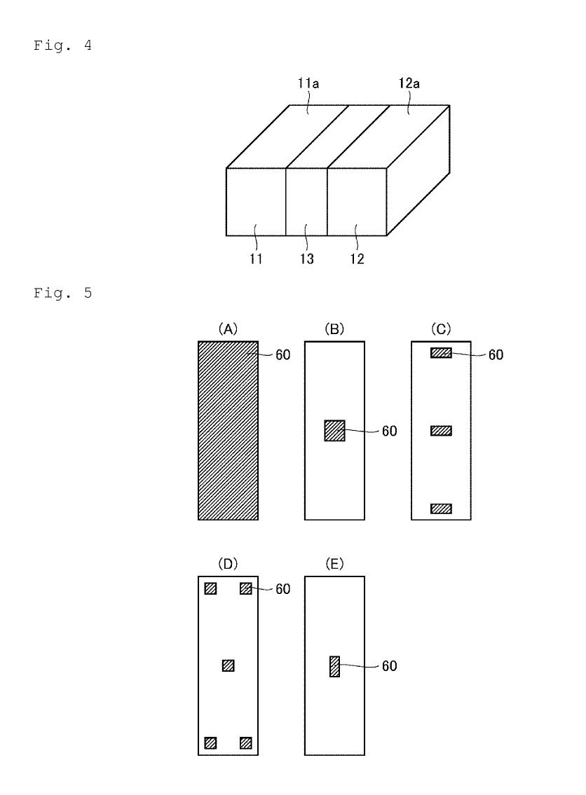

A battery laminate body formed by laminating a positive electrode layer 11, a solid electrolyte layer 13 and a negative electrode layer 12 in order is shown in FIG. 4. The positive electrode layer 11 has a positive electrode connecting surface 11a on a side which is connected to the positive electrode connecting part 21 (FIG. 1 and FIG. 2), and the negative electrode layer 12 has a negative electrode connecting surface 12a on a side which is connected to the negative electrode connecting part 22 (FIG. 1 and FIG. 2).

In the solid state batteries 1 and 2 shown in FIG. 1 and FIG. 2, current collector layers 60, with various patterns shown in FIG. 5, can be formed on each of the positive electrode connecting surface 11a and the negative electrode connecting surface 12a (FIG. 4) as electrode connecting surfaces. As shown in FIG. 5(A), the current collector layer 60 may be formed on the entire surface of the electrode connecting surface. As shown in FIG. 5(B), the current collector layer 60 may be formed on a square-shaped partial surface positioned at a central part of the electrode connecting surface. As shown in FIG. 5(C), the current collector layers 60 may be formed on a plurality (three in FIG. 5(C)) of rectangle-shaped partial surfaces respectively positioned at one end, a central part, and the other end. As shown in FIG. 5(D), the current collector layers 60 may be formed on a plurality of square-shaped partial surfaces respectively positioned at one end (two), a central part (one), and the other end (two). As shown in FIG. 5(E), the current collector layer 60 may be formed on a rectangle-shaped partial surface positioned at a central part of the electrode connecting surface. In addition, the current collector layer 60 is formed on each of the positive electrode connecting surface 11a and the negative electrode connecting surface 12a as a metal layer of gold, silver, platinum or the like by a printing method, a sputtering method or the like. The current collector layers 60 may be formed from a conductive substance such as a carbon material. Further, the battery laminate body is arranged in such a way that the current collector layers 60 respectively formed on the positive electrode connecting surface 11a and the negative electrode connecting surface 12a are superimposed on the surfaces of the positive electrode connecting part 21 and the negative electrode connecting part 22, respectively, formed at the base part 20 (FIG. 1 and FIG. 2).

As shown in FIG. 11, in a fourth embodiment of the present invention, a mounting type solid state battery 4 comprises three battery laminate bodies which are respectively formed by laminating a positive electrode layer 11, a solid electrolyte layer 13 and a negative electrode layer 12 in order and are connected in series, and a case main body housing the three battery laminate bodies. The case main body is composed of a base part 20 and a lid portion 30. In addition, in the neighboring two battery laminate bodies, a current collector layer 23 is disposed between the positive electrode layer 11 of one battery laminate body and the negative electrode layer 12 of the other battery laminate body. The three battery laminate bodies are placed on the surface of the base part 20 so as to be supported by the base part 20. A positive electrode connecting part 21 and a negative electrode connecting part 22 are formed at the base part 20 as an electrode connecting part for bringing an inner side surface of the case main body into conduction with an outer side surface of the case main body. The three battery laminate bodies are arranged on the surface of the base part 20 so that the positive electrode connecting part 21 is connected to the positive electrode layer 11 of the battery laminate body positioned at one end side of the three battery laminate bodies, and the negative electrode connecting part 22 is connected to the negative electrode layer 12 of the battery laminate body positioned at the other end side of the three battery laminate bodies. A lid portion 30 is arranged so as to cover the three battery laminate bodies. The base part 20 is joined to the lid portion 30 by seam welding or the like. In the three battery laminate bodies, the positive electrode layer 11, the solid electrolyte layer 13 and the negative electrode layer 12 are laminated in a direction in which the base part 20 of the case main body extends. An insulating layer 40 is arranged so as to be brought into contact with the surface of the three battery laminate bodies opposite to the surface facing the base part 20. In the fourth embodiment, the insulating layer 40 is disposed between the three battery laminate bodies and the lid portion 30. The base part 20 is formed from ceramic such as alumina, and the lid portion 30 is formed from metal such as Kovar (Co—Ni—Fe alloy). The insulating layer 40 is formed from ceramic such as alumina, synthetic resins such as fluorine resins (tetrafluoroethylene resin, etc.) and polyimide resins, or the like. The positive electrode connecting part 21 and the negative electrode connecting part 22 are formed from metal such as tungsten filled into a through-hole formed in the base part 20. The current collector layer 23 is formed from metal such as gold.

In addition, the number of the battery laminate bodies connected in series is not limited to three and may be two or more. Further, two or more battery laminate bodies connected in series may be housed in the case main body in the form shown in FIG. 2 and FIG. 3.

As shown in FIG. 12, in a fifth embodiment of the present invention, a mounting type solid state battery 5 comprises two battery laminate bodies which are respectively formed by laminating a positive electrode layer 11, a solid electrolyte layer 13 and a negative electrode layer 12 in order and are connected in parallel, and a case main body housing the two battery laminate bodies. The case main body is composed of a base part 20 and a lid portion 30. In the two battery laminate bodies, the positive electrode layers 11 are connected to each other with an electrode layer 24 interposed therebetween, and a conductive layer 25 connects the negative electrode layers 12 to each other. The conductive layer 25 is formed so as to extend over an insulating layer 31 formed on the two battery laminate bodies. The two battery laminate bodies are placed on the surface of the base part 20 so as to be supported by the base part 20. A positive electrode connecting part 21 and a negative electrode connecting part 22 are formed at the base part 20 as an electrode connecting part for bringing an inner side surface of the case main body into conduction with an outer side surface of the case main body. The two battery laminate bodies are arranged on the surface of the base part 20 so that the positive electrode connecting part 21 is connected to the electrode layer 24 which connects the positive electrode layers 11 positioned at a central part of the two battery laminate bodies to each other, and the negative electrode connecting part 22 is connected to the negative electrode layer 12 of the battery laminate body positioned at one end side of the two battery laminate bodies. An insulating lid portion 30 is arranged on the conductive layer 25 so as to cover the two battery laminate bodies. The base part 20 is joined to the lid portion 30. In the two battery laminate bodies, the positive electrode layer 11, the solid electrolyte layer 13 and the negative electrode layer 12 are laminated in a direction in which the base part 20 of the case main body extends. The base part 20 and the lid portion 30 are formed from ceramic such as alumina. The insulating layer 31 is formed from ceramic such as alumina, synthetic resins such as fluorine resins (tetrafluoroethylene resin, etc.) and polyimide resins, or the like. The positive electrode connecting part 21, the negative electrode connecting part 22, the electrode layer 24 and the conductive layer 25 are formed from metal such as tungsten, platinum, copper, or aluminum.

In addition, the number of the battery laminate bodies connected in parallel is not limited to two, and may be two or more. In consideration of a balance between solid state batteries, an even number of battery laminate bodies of two or more are preferably connected. Further, two or more battery laminate bodies connected in parallel may be housed in the case main body in the form shown in FIG. 2 and FIG. 3. Wirings between the positive electrode layers 11 and between the negative electrode layers 12 are not limited to the forms of the above-mentioned electrode layer 24 and conductive layer 25, and the wiring may be formed by a bump layer or the like.

Next, Examples of the solid state battery of the present invention prepared according to the above embodiment will be described. In addition, the embodiment of the solid state battery of the present invention is not limited to the above embodiments.

### EXAMPLES

Hereinafter, Examples 1 to 8 where the solid state batteries of the present invention were prepared will be described.

### Example 1

Li₂S and P₂S₅ were weighed so as to have a molar ratio of 7:3, mixed, mechanically milled, and heated at a temperature of 300° C. for 2 hours, and thereby, a sulfide-based glass ceramics was synthesized. The resulting Li₂S—P₂S₅ as a sulfide-based compound was used as a solid electrolyte. In addition, as the solid electrolyte, sulfide-based compounds such as Li₂S—P₂S₅-GeS₂ and Li₂S—P₂S₅—SiS₂ other than Li₂S—P₂S₅ can also be used. Further, Li₂FeS₂ was used as a positive active material, and graphite was used as a negative active material. In addition, as the positive active material, lithium cobalt oxide, lithium manganese oxide and the like can also be used. In addition, as the negative active material, lithium titanium oxide and the like can also be used.

The positive active material and the solid electrolyte were mixed in a weight ratio of 1:1 to prepare a positive electrode material. Further, the negative active material and the solid electrolyte were mixed in a weight ratio of 1:1 to prepare a negative electrode material. Then, a solid electrolyte layer was prepared by putting the solid electrolyte in a 2.6-millimeter-square die, and pressing the solid electrolyte. The positive electrode material was fitted to one side of the solid electrolyte layer in the die, and the negative electrode material was fitted to the other side of the solid electrolyte layer, and the resulting solid electrolyte layer was pressed at a pressure of 330 MPa to prepare a battery laminate body. A battery laminate body of an all solid state secondary battery was prepared in this manner. In addition, an example of a method for preparing an all solid state secondary battery has been described above, but the preparing method is not limited to the above-mentioned method.

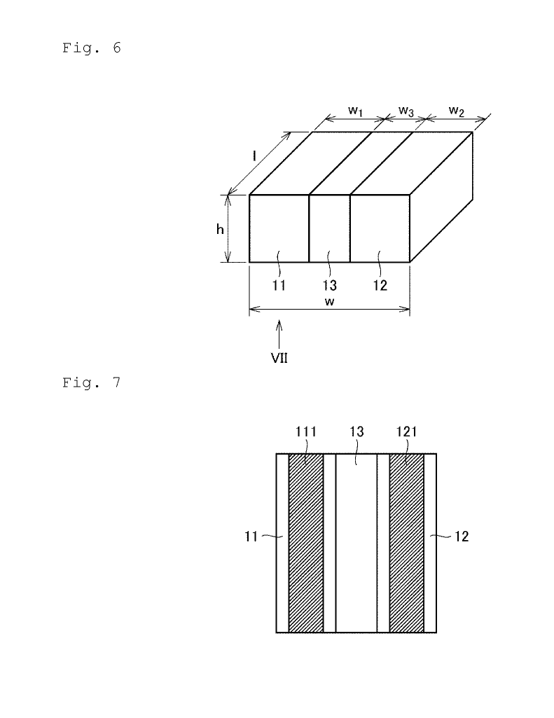

In addition, with respect to the size of the battery laminate body prepared, when as shown in FIG. 6, a dimension in a direction in which a positive electrode layer 11, a solid electrolyte layer 13 and a negative electrode layer 12 are lined (direction of lamination) is denoted by w, a dimension in a direction of a battery height, which faces a mounting surface, is denoted by h, and a dimension in a direction perpendicular to the direction, in which the positive electrode layer 11, the solid electrolyte layer 13 and the negative electrode layer 12 are lined, is denoted by 1, w is 0.75 mm, h is 0.6 mm, and 1 is 2 mm. The width (thickness) w₁ of the positive electrode layer 11 was 300 μm, the width (thickness) w₃ of the solid electrolyte layer 13 was 150 μm, and the width (thickness) w₂ of the negative electrode layer 12 was 300 μm.

Then, as shown in FIG. 7, current collector layers 111, 121 (circuit pattern layers) each composed of a platinum (Pt) layer were formed on one side surfaces of the positive electrode layer 11 and the negative electrode layer 12 of the battery laminate body by a sputtering method.

On the other hand, as a member constituting a case main body as shown in FIG. 1, a base part 20 made of alumina was prepared. A positive electrode connecting part 21 and a negative electrode connecting part 22 respectively made of tungsten are formed at the base part 20. The surfaces of the positive electrode connecting part 21 and the negative electrode connecting part 22 exposed to the surface facing a mounting surface of the base part 20 were plated with nickel (Ni) and with gold (Au), respectively.

Then, the battery laminate body was arranged on the base part 20 in such a way that the current collector layers 111, 121 formed on one side surfaces of the positive electrode layer 11 and the negative electrode layer 12 of the battery laminate body were superimposed on the positive electrode connecting part 21 and the negative electrode connecting part 22, respectively, which were disposed at the base part 20 of the case main body. Moreover, an insulating layer 40 (insulating sheet) made of polyimide was disposed on the battery laminate body.

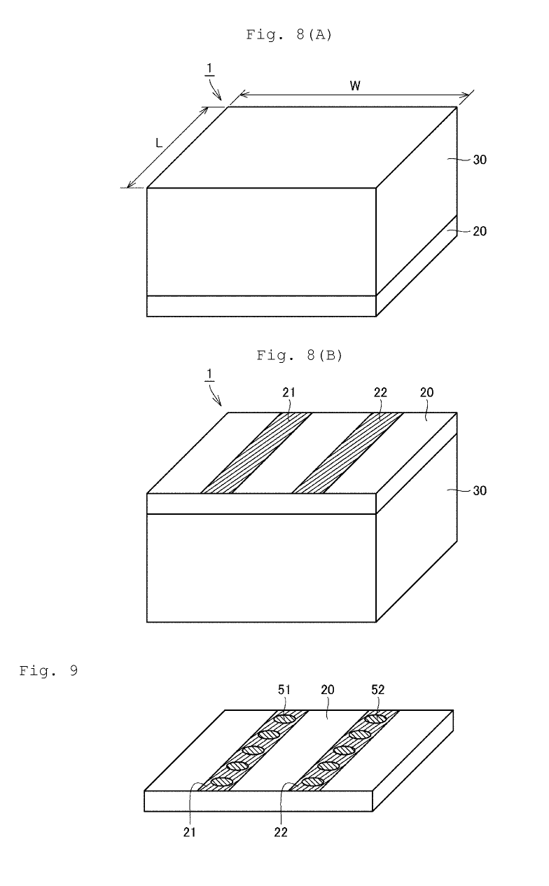

Next, as another member constituting the case main body as shown in FIG. 1, a lid portion 30 made of Kovar (Co—Ni—Fe alloy) was prepared. The lid portion 30 was arranged so as to cover the battery laminate body disposed on the base part 20, and the lid portion 30 was joined to the base part 20 by seam welding, and thereby, a mounting type solid state battery 1 shown in FIG. 1 and FIG. 8, in which dimensions of a mounted surface were 5 mm in length L and 5 mm in width W, was prepared. In addition, in the Example described above, the lid portion 30 made of metal was used, but a ceramic lid portion conventionally used or the like may be used.

A charge-discharge test of the solid state battery 1 prepared as described above was carried out at a current density of 0.8 mA/cm². Consequently, the discharge capacity was 0.1 mAh.

### Example 2

A mounting type solid state battery 3 as described in FIG. 3 was prepared in the same manner as in Example 1. However, an insulating layer 40 shown in FIG. 1 was not disposed. In a positive electrode layer 11 and a negative electrode layer 12 of a battery laminate body, a current collector layer was not formed on one surface facing a base part 20. As shown in FIG. 3, a positive electrode bump layer 51 was disposed between the positive electrode layer 11 and a positive electrode connecting part 21 of the base part 20, and a negative electrode bump layer 52 was disposed between the negative electrode layer 12 and a negative electrode connecting part 22 of the base part 20. Specifically, as shown in FIG. 9, a pattern layer of platinum (Pt) was formed in the form of dots by a vapor deposition method on the positive electrode connecting part 21 and negative electrode connecting part 22 of the base part 20, and the positive electrode bump layer 51 and the negative electrode bump layer 52, which were respectively made of solder, were formed on the formed platinum pattern layer by a printing method.

A charge-discharge test of the solid state battery 3 prepared as described above was carried out in the same manner as in Example 1. Consequently, the discharge capacity was 0.1 mAh.

### Example 3

A mounting type solid state battery 1 described in FIG. 1 was prepared in the same manner as in Example 1. However, in FIG. 6, the width w₁ of the positive electrode layer 11, the width w₂ of the negative electrode layer 12, and the width w₃ of the solid electrolyte layer 13 were set to 300 μm, 300 μm, and 250 μm, respectively.

A charge-discharge test of the solid state battery 1 prepared as described above was carried out in the same manner as in Example 1. Consequently, the discharge capacity was 0.1 mAh.

### Example 4

A mounting type solid state battery 1 described in FIG. 1 was prepared in the same manner as in Example 1. However, in FIG. 6, the width w₁ of the positive electrode layer 11, the width w₂ of the negative electrode layer 12, and the width w₃ of the solid electrolyte layer 13 were set to 300 μm, 300 μm, and 500 μm, respectively.

A charge-discharge test of the solid state battery 1 prepared as described above was carried out in the same manner as in Example 1. Consequently, the discharge capacity was 0.05 mAh.

### Example 5

A mounting type solid state battery 1 described in FIG. 1 was prepared in the same manner as in Example 1. However, in FIG. 6, the width w₁ of the positive electrode layer 11, the width w₂ of the negative electrode layer 12, and the width w₃ of the solid electrolyte layer 13 were set to 1000 μm, 1000 μm, and 150 μm, respectively.

A charge-discharge test of the solid state battery 1 prepared as described above was carried out in the same manner as in Example 1. Consequently, the discharge capacity was 0.4 mAh.

### Example 6

A mounting type solid state battery 1 described in FIG. 1 was prepared in the same manner as in Example 1. However, in FIG. 6, the width w₁ of the positive electrode layer 11, the width w₂ of the negative electrode layer 12, and the width w₃ of the solid electrolyte layer 13 were set to 1500 μm, 1500 μm, and 150 μm, respectively.

A charge-discharge test of the solid state battery 1 prepared as described above was carried out in the same manner as in Example 1. Consequently, the discharge capacity was 0.6 mAh.

### Example 7

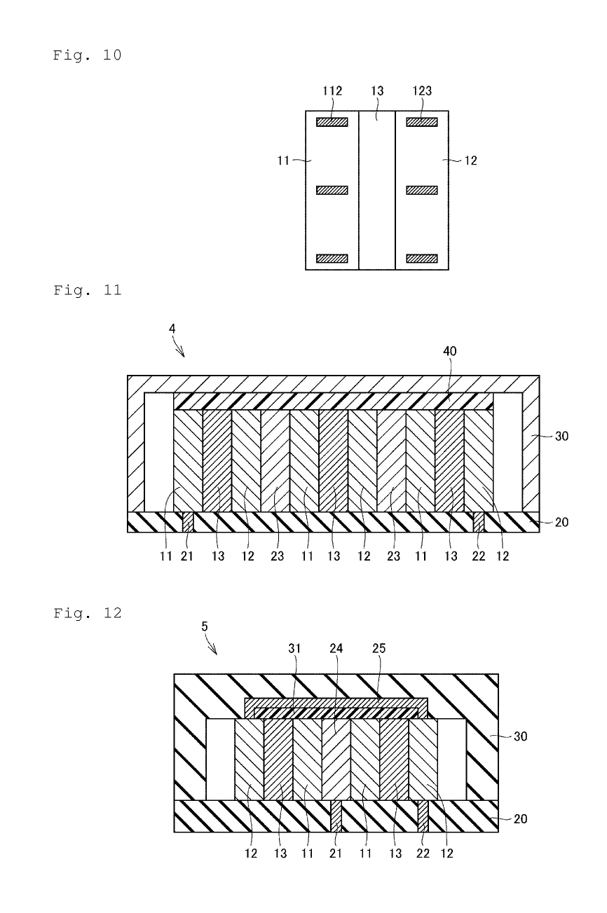

A mounting type solid state battery 1 described in FIG. 1 was prepared in the same manner as in Example 1. However, as shown in FIG. 10, current collector layers 112, 122 (circuit pattern layers: (C) in FIG. 5) each composed of a platinum (Pt) layer were formed on one side surfaces of the positive electrode layer 11 and the negative electrode layer 12 of a battery laminate body by a sputtering method.

A charge-discharge test of the solid state battery 1 prepared as described above was carried out in the same manner as in Example 1. Consequently, the discharge capacity was 0.1 mAh.

### Example 8

A mounting type solid state battery 1 described in FIG. 1 was prepared in the same manner as in Example 1. However, in FIG. 6, the width w₁ of the positive electrode layer 11, the width w₂ of the negative electrode layer 12, and the width w₃ of the solid electrolyte layer 13 were set to 2000 μm, 2000 μm, and 150 μm, respectively.

A charge-discharge test of the solid state battery 1 prepared as described above was carried out in the same manner as in Example 1. Consequently, the discharge capacity was 0.6 mAh.

It is found from the results of the charge-discharge tests in Examples 1, 3 and 4 that when the width w₃ of the solid electrolyte layer 13 is smaller, the discharge capacity of the battery is higher, and therefore the width w₃ of the solid electrolyte layer 13 is preferably small.

It is found from the results of the charge-discharge tests in Examples 1, 5, 6 and 8 that when the width w₁ of the positive electrode layer 11 and the width w₂ of the negative electrode layer 12 are larger, the discharge capacity of the battery is higher. In general, in an all solid state battery, when the width of an electrode is increased, the discharge capacity of the battery often becomes small, but in the solid state battery of the present invention, a high discharge capacity can be achieved even in the case of a large electrode width.

In addition, in the battery laminate body, the electrode width, that is, each of the width w₁ of the positive electrode layer 11 and the width w₂ of the negative electrode layer 12 is preferably larger than the width w₃ of the solid electrolyte layer 13. When the width w₃ of the solid electrolyte layer 13 is large, resistance is increased, the resulting capacity is decreased, a rate characteristic is also deteriorated and a capacity per volume of the battery is reduced.

Further, the width w₃ of the solid electrolyte layer 13 is preferably 150 μm or more and 300 μm or less. When the width w₃ of the solid electrolyte layer 13 falls within the above-mentioned range, a battery having excellent battery characteristics can be obtained. When the width w₃ of the solid electrolyte layer 13 is out of the above-mentioned range, the battery characteristics are slightly low.

Moreover, the electrode width, that is, each of the width w₁ of the positive electrode layer 11 and the width w₂ of the negative electrode layer 12 is preferably 300 μm or more and 2000 μm or less. When the electrode width is more than 1000 μm, an overvoltage is high and the voltage to be applied reaches an end voltage quickly. When the electrode width is less than 300 μm, the capacity becomes small. The electrode width is more preferably 300 μm or more and 1500 μm or less.

It should be considered that the embodiments and Examples disclosed herein are illustrative in all respects and are not intended to be restrictive. The scope of the present invention is defined by the claims rather than by the above-mentioned embodiments and examples, and all modifications and variations which fall within the scope of the claims, or equivalence of the scope of the claims are therefore intended to be embraced by the claims.

A solid state battery which can be easily mounted on a substrate can be obtained, and a mounting type solid state battery can be downsized.

### DESCRIPTION OF REFERENCE SYMBOLS

1,2,3,4,5: solid state battery; 11: positive electrode layer; 12: negative electrode layer,; 13: solid electrolyte layer; 20: base part (of a case main body); 21: positive electrode connecting part; 22: negative electrode connecting part; 24: electrode layer; 25: conductive layer; 30: lid part (of a case main body); 31, 40: insulating layer; 51: positive electrode bump layer; 52: negative electrode bump layer; 23, 60, 111, 112, 121, 122: current collector layer

1. A solid state battery comprising:
a battery laminate body having a positive electrode layer, a solid electrolyte layer and a negative electrode layer; and
a case main body housing the battery laminate body, the case main body having a base part which supports the battery laminate body,
wherein battery laminate body is arranged such that a laminate direction of the positive electrode layer and the negative electrode layer extends in a direction parallel to the base part of the case main body.

2. The solid state battery according to claim 1, further comprising an electrode connecting part at the base part of the case main body, the electrode connecting part being configured to bring an inner side surface of the case main body into conduction with an outer side surface of the case main body.

3. The solid state battery according to claim 2, wherein the electrode connecting part includes a positive electrode connecting part arranged for connection to the positive electrode layer and a negative electrode connecting part arranged for connection to the negative electrode layer.

4. The solid state battery according to claim 3, further comprising a first current collector layer between the positive electrode layer and the positive electrode connecting part and a second current collector layer between the negative electrode layer and the negative electrode connecting part.

5. The solid state battery according to claim 4, wherein the battery laminate body has a first surface opposite to the inner surface of the case main body and second surface opposite to the first surface, the solid state battery further comprising an insulating layer arranged adjacent to the second surface of the battery laminate body.

6. The solid state battery according to claim 5, wherein the case main body has a lid portion arranged so as to cover the battery laminate body, and the insulating layer is disposed between the lid portion and the battery laminate body.

7. The solid state battery according to claim 5, wherein the insulating layer is in contact with the second surface of the battery laminate body.

8. The solid state battery according to claim 5, wherein the case main body has a lid portion arranged so as to cover the battery laminate body, and the insulating layer is a part of the lid portion.

9. The solid state battery according to claim 3, further comprising a first bump layer on the positive electrode connecting part and connected to the positive electrode layer and a second bump layer on the negative electrode connecting part and connected to the negative electrode layer.

10. The solid state battery according to claim 7, wherein the case main body has a lid portion covering the battery laminate body.

11. The solid state battery according to claim 1, wherein the case main body has a lid portion covering the battery laminate body.

12. The solid state battery according to claim 11, further comprising an insulating layer arranged between the battery laminate body and the lid portion.

13. The solid state battery according to claim 12, wherein the insulating layer is part of the lid portion.

14. The solid state battery according to claim 1, further comprising a plurality of the battery laminate bodies arranged adjacent to each other along the base part of the case main body such that a laminate direction of the positive electrode layers and the negative electrode layers of each of the plurality of battery laminate bodies extends in a direction parallel to the base part of the case main body.

15. The solid state battery according to claim 14, further comprising a current collection layer disposed between adjacent battery laminate bodies of the plurality of battery laminate bodies.

16. The solid state battery according to claim 14, further comprising a conductive layer disposed between adjacent battery laminate bodies of the plurality of battery laminate bodies.

17. The solid state battery according to claim 14, wherein the case main body has a lid portion covering the plurality of battery laminate bodies.

18. The solid state battery according to claim 17, further comprising an insulating layer arranged between the plurality of battery laminate bodies and the lid portion.

19. The solid state battery according to claim 18, wherein the insulating layer is part of the lid portion.
